(19) United States
(12) Patent Application Publication
(10) Pub. No.: US 2008/0309710 A1
(43) Pub. Date: Dec. 18, 2008

(54) LIQUID EJECTING APPARATUS

(75) Inventor: Masato MURAYAMA, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/137,750

(22) Filed: Jun. 12, 2008

(30) Foreign Application Priority Data
Jun. 13, 2007 (JP) 2007-156815

(51) Int. Cl. B41J 2/145

(52) U.S. Cl. 347/40

(57) ABSTRACT

A liquid ejecting apparatus includes nozzles that eject a liquid, and n number of nozzle groups. Dot rows along a transport direction formed within the nozzle groups include alternating dense areas and sparse areas. A length in a direction of the dot rows from one of the dense areas to another of the dense areas is a predetermined length. A length in the dot row direction from a particular one of the dense areas of one of the dot rows formed with a certain one of the nozzle groups among n number of nozzle groups to a particular one of the dense areas of one of the dot rows formed with another of the nozzle groups, is equal to a length resulting from adding a non-negative integral multiple of the predetermined length to a length obtained by dividing the predetermined length by n.

### BACKGROUND

1. Technical Field

The present invention relates to a liquid ejecting apparatus.

2. Related Art

As one example of a liquid ejecting apparatus, an ink jet printer that performs printing by ejecting ink from nozzles onto various media, such as paper, a cloth, or a film, is known. In recent years, among ink jet printers, a line head printer including a nozzle row having a length of a sheet width of a medium along a direction crossing a transport direction is being developed.

In ink jet printers, uneven density may occur in a printed image due to ink drops not landing upon correct positions of a medium as a result of a transport error caused by, for example, a manufacturing error of a transport roller.

A method of controlling the amount of rotation of a transport roller and a method of controlling an ink ejecting timing in accordance with a transport error that occurs are proposed (refer to JP-A-5-24186).

However, since a line head printer includes a plurality of nozzles, it takes time to perform a correction calculation for controlling the ink ejecting timing. In addition, since the line head printer including a plurality of nozzles (heads) is large, even if the amount of rotation of the transport roller is changed in accordance with the transport error, a time difference up to when a transport speed changes actually occurs. Therefore, the transport error cannot be overcome. As a result, an uneven density occurs.

### SUMMARY

An advantage of an aspect of the invention is that uneven density is reduced.

According to an aspect of the invention, a liquid ejecting apparatus includes a transport mechanism that transports a medium in a transport direction with respect to nozzles that eject a liquid, and n number of nozzle groups. Dot rows along the transport direction formed with the nozzle groups are formed by alternately disposing in parallel, dense areas, where dot intervals of the dot rows are small, and sparse areas, where dot intervals of the dot rows are large. A length in a direction of the dot rows from a central portion of a particular one of the dense areas to a central portion of another particular one of the dense areas is a predetermined length. A length in the dot row direction from a central portion of a particular one of the dense areas of one of the dot rows formed with a certain one of the nozzle groups among the n number of nozzle groups to a central portion of a particular one of the dense areas of one of the dot rows formed with another one of the nozzle groups, differing from the certain one of the nozzle groups, is equal to a length resulting from adding an integral multiple of the predetermined length to a length obtained by dividing the predetermined length by n. The integral multiple is greater than or equal to zero.

Other features according to the invention will become apparent from the specification and the attached drawings.

### BRIEF DESCRIPTION OF THE DRAWINGS

The invention will be described with reference to the accompanying drawings, wherein like numbers reference like elements.

FIG. 1 is a block diagram of an overall structure of a printer according to an embodiment of the invention.

FIG. 2A is a sectional view of the printer.

FIG. 2B is a schematic view of transportation of a sheet.

FIG. 3 is a plan view of head units.

FIG. 4 shows driving signals for ink ejection.

FIG. 5A shows in detail a transporting unit.

FIGS. 5B to 5D each illustrate a manufacturing error of a transport roller.

FIGS. 6A and 6B each illustrate an image of an ideal printer.

FIGS. 7A, 7B, and 7C each illustrate a printer image of a printer of a comparative example.

FIG. 8A is a graph showing a transport characteristic of the printer according to the embodiment.

FIG. 8B shows a relationship between transport speed and a certain area on a sheet.

FIGS. 8C and 8D are each enlarged views of an image of the printer according to the embodiment.

FIG. 9 shows a method of detecting the transport characteristic with a speed detection sensor.

FIG. 10 is a flowchart of a manufacturing method example 1.

FIG. 11 illustrates a detection of the transport characteristic.

FIG. 12 is a flowchart of a manufacturing method example 2.

FIG. 13A illustrates a first test pattern.

FIGS. 13B and 13C illustrate a second test pattern.

FIG. 14A illustrates a detection of the transport characteristic.

FIG. 14B illustrates a third test pattern.

FIG. 15 is a flowchart showing a manufacturing method example 3.

FIG. 16 illustrates a fine adjustment mechanism of the printer.

FIGS. 17A, 17B, and 17C illustrate another embodiment.

FIGS. 18A, 18B, and 18C illustrate still another embodiment.

FIG. 19 illustrates the still another embodiment.

### DESCRIPTION OF EXEMPLARY EMBODIMENTS

### Outline of the Disclosure

The description of the specification and the attached drawings at least make the following obvious.

According to a first aspect of the invention, a liquid ejecting apparatus includes a transport mechanism that transports a medium in a transport direction with respect to nozzles that eject a liquid, and n number of nozzle groups. Dot rows along the transport direction formed with the nozzle groups are formed by alternately disposing in parallel, dense areas, where dot intervals of the dot rows are small, and sparse areas, where dot intervals of the dot rows are large. A length in a direction of the dot rows from a central portion of a particular one of the dense areas to a central portion of another particular one of the dense areas is a predetermined length. A length in the dot row direction from a central portion of a particular one of the dense areas of one of the dot rows formed with a certain one of the nozzle groups among the n number of nozzle groups to a central portion of a particular one of the dense areas of one of the dot rows formed with another one of the nozzle groups, differing from the certain one of the nozzle groups, is equal to a length resulting from adding an integral multiple of the predetermined length to a length obtained by dividing the predetermined length by n. The integral multiple is greater than or equal to zero.

According to such a liquid ejecting apparatus, the dot rows formed with a certain nozzle group and the dot rows formed with another nozzle group that is different from the certain nozzle group cause the dot formation density differences to be reduced, so that uneven density is reduced. For example, when an area in which the dot rows of the certain nozzle group are densely formed and an area in which the dot rows of the different nozzle group are sparsely formed are disposed side by side so as to intersect with the transport direction, the uneven density is reduced.

According to a second aspect of the invention, a liquid ejecting apparatus includes a transport mechanism that transports a medium in a transport direction with respect to nozzles that eject a liquid, a first upstream-side nozzle group, and a first downstream-side nozzle group positioned downstream from the first upstream-side nozzle group in the transport direction. An interval between a particular one of the nozzles of the first upstream-side nozzle group and a particular one of the nozzles of the first downstream-side nozzle group is equal to a distance that the medium is transported in a duration resulting from adding a duration of an integral multiple period to a duration of a half period of a period in which a speed change occurs due to a transport characteristic of the transport mechanism. The integral multiple is greater than or equal to zero.

According to such a liquid ejecting apparatus, when a value of a speed error (transport characteristic) occurring when a certain area of the medium opposes the upstream-side nozzle group and a value of a speed error occurring when the certain area of the medium opposes the downstream-side nozzle group become symmetrical values, and when the dot rows formed with the upstream-side nozzle group and the downstream-size nozzle group are combined, the dot formation density differences are reduced. As a result, uneven density caused by the transport error can be reduced.

It is preferable that a type of liquid ejected from the first upstream-side nozzle group be the same as a type of liquid ejected from the first downstream-side nozzle group, and that the first downstream-side nozzle group form dot rows along the transport direction between dot rows formed along the transport direction with the first upstream-side nozzle group.

According to such a liquid ejecting apparatus, the dot formation density differences can be reduced by combining the dot rows formed with the upstream-side nozzle group and the downstream-side nozzle group.

It is preferable that the liquid ejecting apparatus further include a second upstream-side nozzle group positioned between the first upstream-side nozzle group and the first downstream-side nozzle group, and a second downstream-side nozzle group positioned downstream from the first downstream-side nozzle group in the transport direction. An interval between a particular one of the nozzles of the second upstream-side nozzle group and a particular one of the nozzles of the second downstream-side nozzle group is equal to a distance that the medium is transported in the duration resulting from adding the duration of the integral multiple period to the duration of the half period of the period in which the speed change occurs. The integral multiple is greater than or equal to zero.

According to such a liquid ejecting apparatus, reducing the interval between the first upstream-side nozzle group and the second upstream-side nozzle group (and the interval between the first downstream-side nozzle group and the second downstream-side nozzle group) makes it possible to minimize the size of the apparatus in the transport direction even if the number of nozzle groups is further increased.

It is preferable that, when an area of the medium opposing the first upstream-side nozzle group when the medium is transported at a speed that is higher than a speed specified on the basis of the transport characteristic opposes the first downstream-side nozzle group, the medium be transported at a speed that is lower than the speed specified on the basis of the transport characteristic.

According to such a liquid ejecting apparatus, even if the upstream-side nozzle group forms a dot row whose dot interval in the transport direction is wider than the specified interval, the downstream-side nozzle group forms a dot row whose dot interval in the transport direction is narrower than the specified interval. Therefore, the dot formation density differences are reduced, thereby making it possible to reduce uneven density occurring due to the transport characteristic.

According to a third aspect of the invention, a liquid ejecting apparatus includes a transport mechanism that transports a medium in a transport direction with respect to nozzles that eject a liquid, and n number of nozzle groups. An interval between a particular one of the nozzles of an upstream-side nozzle group among two of the nozzle groups that are adjacent to each other in the transport direction and a particular one of the nozzles of a downstream-side nozzle group among the two of the nozzle groups that are adjacent to each other in the transport direction is equal to a distance that the medium is transported in a duration resulting from adding a duration of an integral multiple period to a duration of a period obtained by dividing a period of a speed change, caused by a transport characteristic of the transported mechanism, by n. The integral multiple is greater than or equal to zero.

According to such a liquid ejecting apparatus, when a value of a speed error (transport characteristic) occurring when a certain area of the medium opposes the upstream-side nozzle group and a value of a speed error occurring when the certain area of the medium opposes the downstream-side nozzle group become symmetrical values, and when the dot rows formed with the upstream-side nozzle group and the downstream-size nozzle group are combined, the dot formation density differences are reduced. As a result, uneven density caused by the transport error can be reduced.

### Line Head Printer

The liquid ejecting apparatus will hereunder be an ink jet printer. The ink jet printer will be a line head printer (printer 1) for describing an embodiment.

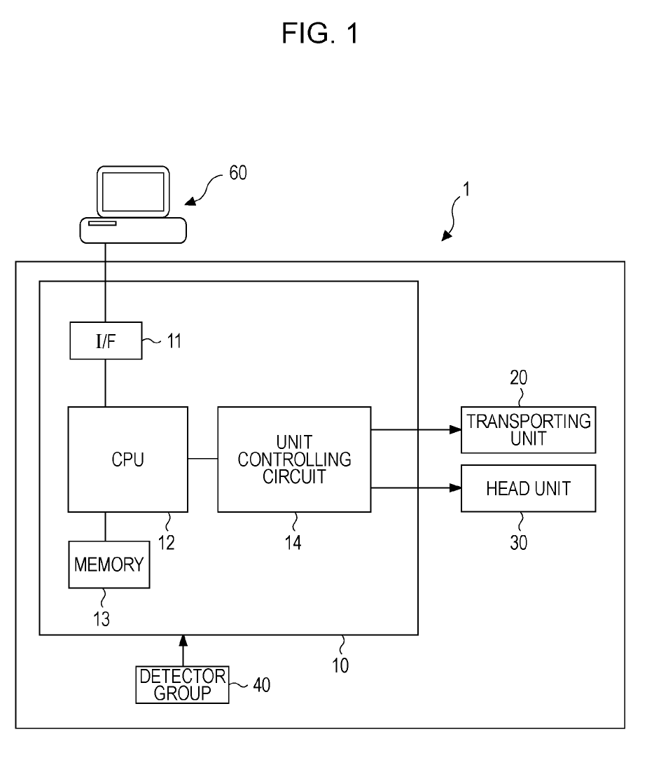

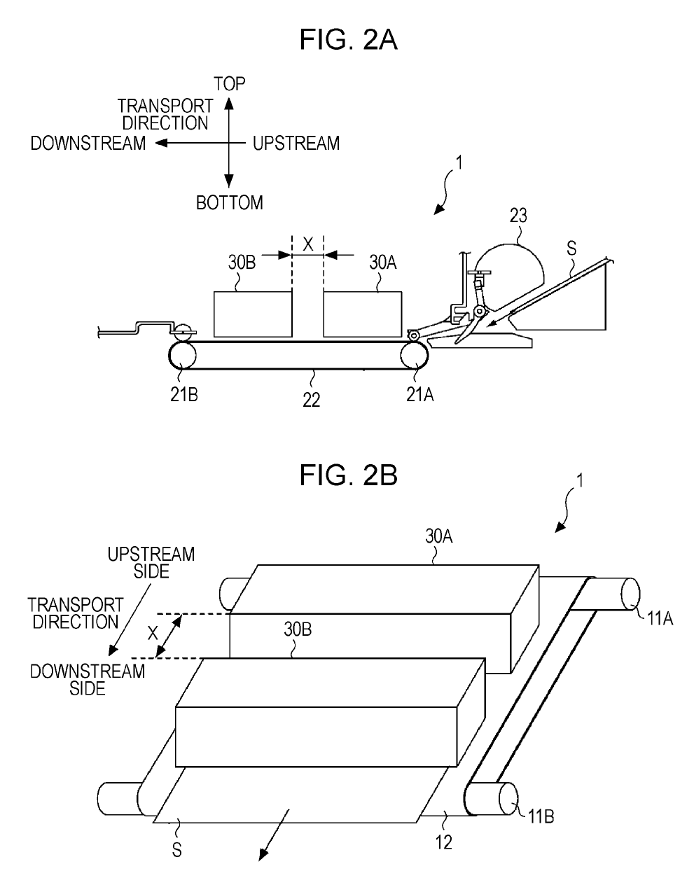

FIG. 1 is a block diagram of an overall structure of the printer 1 according to the embodiment of the invention. FIG. 2A is a sectional view of the printer 1. FIG. 2B shows a state of transportation of a sheet S (medium). In the printer 1, which has received print data from a computer 60 (which is an external apparatus), a controller 10 controls each unit (transporting unit 20, head unit 30), to form an image on the sheet S. In addition, a detector group 40 monitors a state of the interior of the printer 1. On the basis of a detection result thereof, the controller 10 controls each unit.

The controller 10 is a control unit for controlling the printer 1. An interface section 11 is provided for exchanging data between the printer 1 and the computer 60 (external apparatus). A CPU 12 is an arithmetic processing unit for controlling the entire printer 1. A memory 13 is provided for providing, for example, a working area or an area for storing a program of the CPU 12. The CPU 12 controls each unit with a unit controlling circuit 14 in accordance with the program stored in the memory 13.

The transporting unit 20 sends a sheet S to a position where printing can be performed and transports the sheet S by a predetermined transport amount in a transport direction during the printing. A sheet-feed roller 23 is provided for automatically feeding a sheet S, inserted into a sheet-insertion opening, onto a transport belt 22 in the printer 1. The annular transport belt 22 is rotated by a transport roller 21A and a transport roller 21B, so that the sheet S on the transport belt 22 is transported. The sheet S is attracted to the transport belt 22 by electrostatic attraction or vacuum attraction (not shown).

The head unit 30 is used for ejecting ink onto the sheet S, and includes a plurality of heads 31. A plurality of nozzles (which are ink ejecting portions) are provided in the lower surface of each head 31. Each nozzle includes a pressure chamber (not shown) containing ink, and a driving element (piezo element) for ejecting the ink as a result of changing the volume of the corresponding pressure chamber. The printer 1 according to the embodiment includes two of the head units 30. The head unit 30 positioned at the upstream side in the transport direction is called an upstream-side head unit 30A (corresponding to an upstream-side nozzle group). The head unit 30 positioned downstream from the upstream-side head unit 30A is called a downstream-side head unit 30B (corresponding to a downstream-side nozzle group). The upstream-side head unit 30A and the downstream-side head unit 30B are disposed apart from each other by an interval X.

### Printing Procedure

When the controller 10 receives a print command and print data from the computer 60, the controller 10 analyzes various commands included in the print data, and performs the following steps using each unit.

The controller 10 causes the sheet-feed roller 23 to rotate, to send a sheet S to be printed onto the transport belt 22. The sheet S is transported at a constant speed onto the transport belt 22 without being stopped, and passes under the upstream-side head unit 30A and the downstream-side head unit 30B. While the sheet S passes below the head units 30, ink is continuously ejected from each nozzle. As a result, dot rows (raster lines), formed by a plurality of dots, are formed on the sheet S in the transport direction. Finally, the controller 10 causes the sheet S at which image printing is completed to be discharged.

### Nozzle Plane

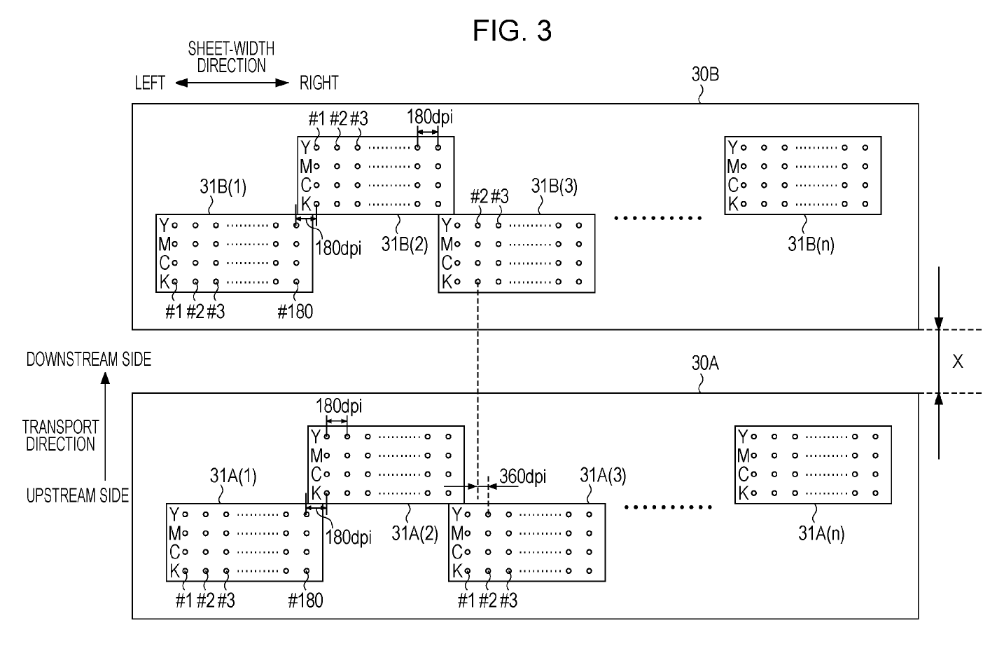

FIG. 3 shows dispositions of the nozzles in the lower surface of the upstream-side head unit 30A and in the lower surface of the downstream-side head unit 30B. Each head unit 30 includes the plurality of heads 31. The number of heads 31 is represented by n. The heads 31 are disposed in a staggered arrangement in a sheet-width direction intersecting with the transport direction. The heads of the upstream-side head unit 30A are called upstream-side heads 31A, and the heads of the downstream-side head unit 30B are called downstream-side heads 31B. In addition, the heads are labeled with numbers in parentheses starting from the left head in the sheet-width direction as follows: first head 31 (1), second head 31 (2), . . .

The lower surface of each head 31 includes a yellow ink nozzle row Y, a magenta ink nozzle row M, a cyan ink nozzle row C, and a black ink nozzle row K. Each nozzle row includes 180 nozzles that are labeled with numbers of increasing values (#1 to #180) starting from the leftmost nozzle in the corresponding nozzle row. In addition, the nozzles of each nozzle row are arranged at a constant interval of 180 dpi in the sheet-width direction.

In each head unit 30, each head 31 is disposed so that the nozzle #180 of the left head 31 of the two heads 31 disposed side by side in the sheet-width direction is separated from the nozzle #1 of the right head 31 of the two heads 31 disposed side by side in the sheet-width direction by an interval of 180 dpi. For example, the nozzle #180 of the downstream-side first head 31B(1) is separated from the nozzle #1 of the downstream-side second head 31B(2) by an interval of 180 dpi. That is, in each head unit 30, the nozzles (YMCK) of four colors are disposed side by side in the sheet-width direction at an interval of 180 dpi.

The nozzles of the upstream-side head unit 30A are displaced from the nozzles of the downstream-side head unit 30B towards the right in the sheet-width direction by an interval of 360 dpi. For example, the nozzle #2 of the upstream-side third head 31A(3) is disposed towards the right from the nozzle #2 of the downstream-side third head 31B(3) by an interval of 360 dpi. Therefore, when the sheet S passes below the upstream-side head unit 30A, an image of 180 dpi is printed in the sheet-width direction. In addition, when the sheet S passes below the downstream-side head unit 30B, the downstream-side head unit 30B prints an image of 180 dpi in the sheet-width direction at a position that is displaced by 360 dpi from the previously printed image.

To recapitulate, the colors (YMCK) of ink ejected from the upstream-side head unit 30A are the same as the colors (YMCK) of ink ejected from the downstream-side head unit 30B. The nozzles of the upstream-side head unit 30A and the nozzles of the downstream-side head unit 30B are displaced from each other by an interval of 360 dpi in the sheet-width direction. Therefore, when the dot rows along the transport direction formed with the upstream-side head unit 30A are disposed side by side in the sheet-width direction with the dot rows along the transport direction formed with the downstream-side head unit 30B, images having a resolution of 360 dpi can be printed in the sheet-width direction.

### Ink Ejecting Method

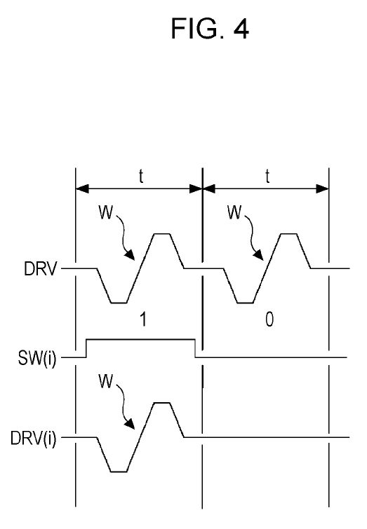

FIG. 4 shows driving signals DRV for ejecting ink from the nozzles. Each driving signal DRV includes a drive pulse W in an ejection period t. By applying the drive pulse W to the piezo element of each nozzle, the volume of the corresponding pressure chamber containing ink changes to eject the ink. Each nozzle includes a switch (not shown) that applies the drive signal DRV to the corresponding piezo element or intercepts the drive signal DRV. Each switch is controlled by a switch control signal SW.

For example, when a switch control signal SW(i) with respect to the nozzle #i is 1, the switch corresponding to the nozzle #i is turned on, so that the corresponding driving pulse W is applied to the corresponding piezo element. The driving pulse W causes the piezo element to become deformed, so that ink in the pressure chamber is ejected from the nozzle #i. In contrast, when the switch control signal SW is 0, the corresponding switch is turned off, so that the corresponding driving pulse W is intercepted. Therefore, the driving pulse W is not applied to the corresponding piezo element, so that ink is not ejected from the nozzle #i.

Accordingly, in accordance with the print data (switch control signal SW), ink is ejected or is not ejected from each nozzle at the interval of ejection period t. Therefore, the sheet S is transported so that the time during which one nozzle and one predetermined pixel on the sheet S oppose each other becomes the ejection period t. Here, the term “pixel” refers to a unit area of an image formed by pixels disposed two-dimensionally in parallel. When printing is performed when a value of (a transport direction×sheet-feed direction resolution) is equal to (360 dpi×360 dpi), the size of one pixel is equal to ( 1/360 inches× 1/360 inches).

### Uneven Density

The speed at which the transporting unit 20 transports the sheet S is hereunder a command transport speed V (corresponding to a specified speed) so that the time during which one pixel ( 1/360 inches) and one nozzle oppose each other becomes the ejection period t. In addition, when the sheet S is transported at a constant speed without changing the command transport speed V, and ink is ejected from each nozzle at the interval of the ejection period t, dot rows having a dot interval of 1/360 inches in the transport direction (length of one pixel in the transport direction) are formed. However, actually, the transport speed is not constant due to transport errors occurring due to, for example, manufacturing errors of the transport roller 21. Therefore, the dot interval in the transport direction becomes wider and narrower than the 1/360 inches. As a result, the density of the printed image becomes uneven, thereby reducing image quality. Next, the occurrence of uneven density due to a transport error will be described in more detail.

### Transport Characteristic

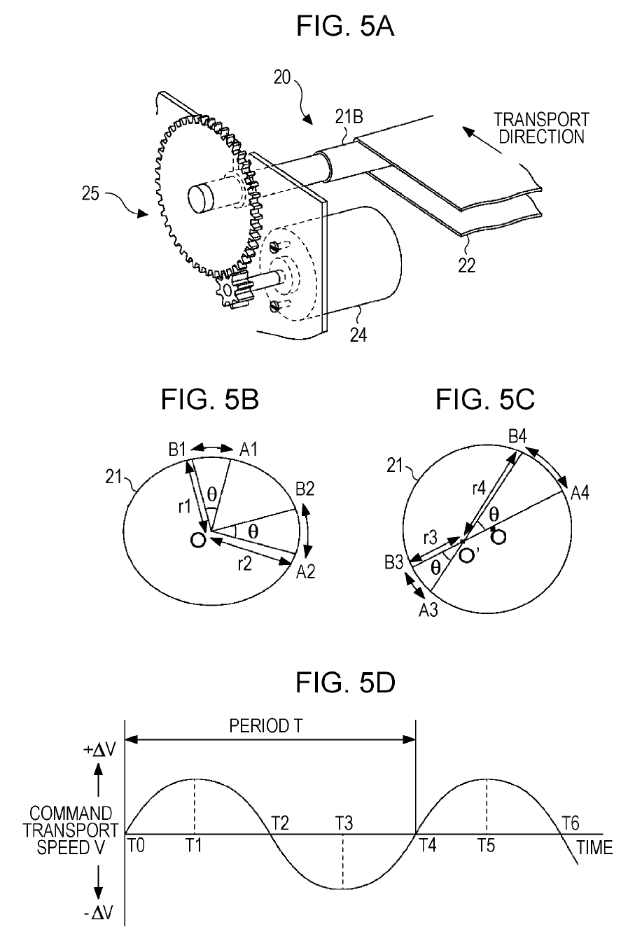

FIG. 5A shows in detail the transporting unit 20. In the embodiment, the downstream-side transport roller 21B is a driving roller. Rotational force of a transport motor 24 is transmitted to the downstream-side transport roller 21B through a transmission mechanism 25 including, for example, a gear. Rotation of the downstream-side transport roller 21B causes the transport belt 22 and the upstream-side transport roller 21A (which is a driven roller) to rotate, so that the sheet S is transported.

Therefore, a rotation amount (rotation angle) of the downstream-side transport roller 21B causes a feed amount of the transport belt 22 to change, thereby changing a transport amount of the sheet S. In other words, the controller 10 of the printer 1 controls the rotation amount of the downstream-side transport roller 21B in accordance with the transport amount of the sheet S. In the embodiment, for transporting the sheet S at the command transport speed V, the controller 10 rotates the downstream-side transport roller 21B so that the sheet S is transported by 1/360 inches (length of one pixel in the transport direction) in the ejection period t.

FIGS. 5B and 5C each illustrate a manufacturing error of the transport roller 21. FIG. 5B shows a state in which the cross section of the transport roller 21 is pressed into an elliptical shape rather than a circular shape. In this case, even if the transport roller 21 is rotated by a rotation amount corresponding to the transport amount of the sheet S, the transport amount of the sheet S differs depending upon a location of the transport roller 21. This is because the distance from a rotation center O of the transport roller 21 to the outer periphery of the transport roller 21 depends upon locations thereof. For example, when the distance from the rotation center O to the outer periphery of the circular transport roller 21 is r (not shown), and the transport roller 21 is rotated by an angle θ, the sheet S is transported by a predetermined transport amount. Here, as shown in FIG. 5B, when the distance from the rotation center O to the outer periphery is smaller than r (that is, the distance equals r1), even if the transport roller 21 is rotated by the angle θ, the sheet S is transported by a transport amount that is less than the predetermined transport amount (that is, A1−B1). In contrast, as shown in FIG. 5B, when the distance from the rotation center O to the outer periphery is greater than r (that is, the distance equals r2), rotating the transport roller 21 by the angle θ causes the sheet S to be transported by a transport amount that is larger than the predetermined transport amount (that is, A2−B2).

FIG. 5C shows a state in which a rotation center O′ of the transport roller 21 is displaced from the actual rotation center O. Even in this case, similarly to the transport roller whose cross section is pressed into an elliptical shape (FIG. 5B), the distance from the rotation center O′ to the outer periphery of the transport roller 21 differs depending upon locations thereof. Therefore, even if the transport roller 21 is rotated by the angle θ, the sheet S is transported by an amount that is smaller than the predetermined transport amount (that is, A3−B3) or by an amount that is larger than the predetermined transport amount (that is, A4−B4).

That is, even if the controller 10 causes the downstream-side transport roller 21B to rotate by a rotation amount in accordance with the predetermined transport amount ( 1/360 inches) of the sheet S in the predetermined period (ejection period t), a manufacturing error (pressing of the cross section or displacement of the rotation center) of the transport roller 21 prevents the sheet S from being transported by the predetermined amount, thereby resulting in a transport error. In other words, even if the transport roller 21 is rotated by a constant rotation amount in a constant duration so that the sheet S is transported at the command transport speed V, the transport speed of the sheet S does not become constant, thereby changing the transport speed.

However, when a design length of the outer periphery of the transport roller 21 and an actual-device length of the outer periphery of the transport roller 21 are equal to each other, even if the cross section of the transport roller 21 is pressed or the rotation center is displaced, rotating the transport roller 21 results in a transport error of zero. That is, while the transport roller 21 rotates once, the transport amount of the sheet S with respect to the constant rotation amount of the transport roller 21 becomes larger or smaller, so that a final transport error is zero. Therefore, the change in speed caused by the transport error occurring when the transport roller 21 rotates once is repeated each time the transport roller 21 rotates.

FIG. 5D is a graph showing a periodic speed change occurring due to a transport error of the transporting unit 20. The horizontal axis represents time, and the vertical axis represents a speed error ΔV with respect to the command transport speed V. When (from a time T0 to a time T2) the sheet S is transported by a transport amount that is larger than the predetermined transport amount ( 1/360 inches) in the constant period (ejection period t), the transport speed (V+ΔV) of the sheet becomes greater than the command transport speed V. In contrast, when (from a time T2 to a time T4) the sheet S is transported by a transport amount that is less than the predetermined transport amount in the constant period, the transport speed (V−ΔV) of the sheet S becomes less than the command transport speed V. In addition, a speed change with respect to the command transport speed V is repeated with each period T.

Such a sinusoidal periodic speed change is defined as a transport characteristic of the transporting unit 20. The transport characteristic is influenced not only by a manufacturing error of the transport roller 21, but also by, for example, a displacement of the rotation center of the transmission mechanism 25 or the transport motor 24, rotational precision of the transport motor 24, or a degree of stretching of the transport belt 22. Therefore, the transport characteristic differs depending upon printers.

### Occurrence of Uneven Density

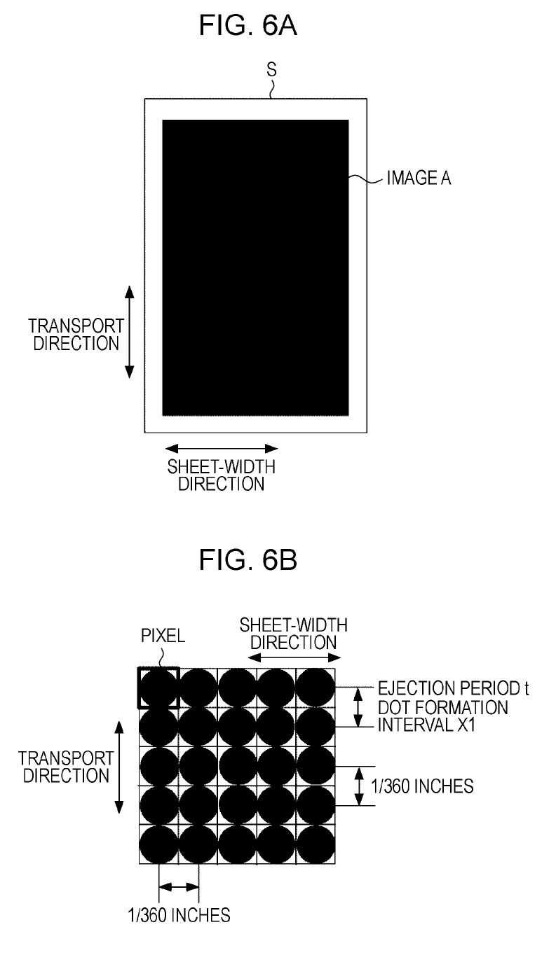

FIG. 6A shows an image A printed by an ideal printer that does not produce a transport error. FIG. 6B is an enlarged view of the image A. Here, while the sheet S is transported at the constant command transport speed V without any transport error, ink is ejected at the interval of ejection period t with respect to the sheet S from each nozzle of the upstream-side head unit 30A and the downstream-side head unit 30B. By printing the image A with both the upstream-side head unit 30A and the downstream-side head unit 30B, the image A is printed with a resolution of 360 dpi in the sheet-width direction. Therefore, as shown in FIG. 6B, the interval between adjacent dots in the sheet-width direction is 1/360 inches. Since the sheet S is transported by 1/360 inches (that is, the length of one pixel in the transport direction) during the ejection period t, the interval between the adjacent dots in the transport direction is 1/360 inches. Accordingly, when the sheet S is transported by the constant transport speed without any transport error, the intervals between the adjacent dots becomes equal to each other, so that the image A having a constant density over the entire surface thereof is formed as shown in FIG. 6A.

Next, a printer according to a comparative example will be described. In this printer, a speed change occurs due to a transport error. When an area of the sheet S opposes the upstream-side head unit 30A when a transport speed of a sheet S is greater (or less) than the command transport speed V, the transport speed of the sheet S when the area of the sheet opposes the downstream-side head unit 30B is also greater (or less) than the command transport speed V.

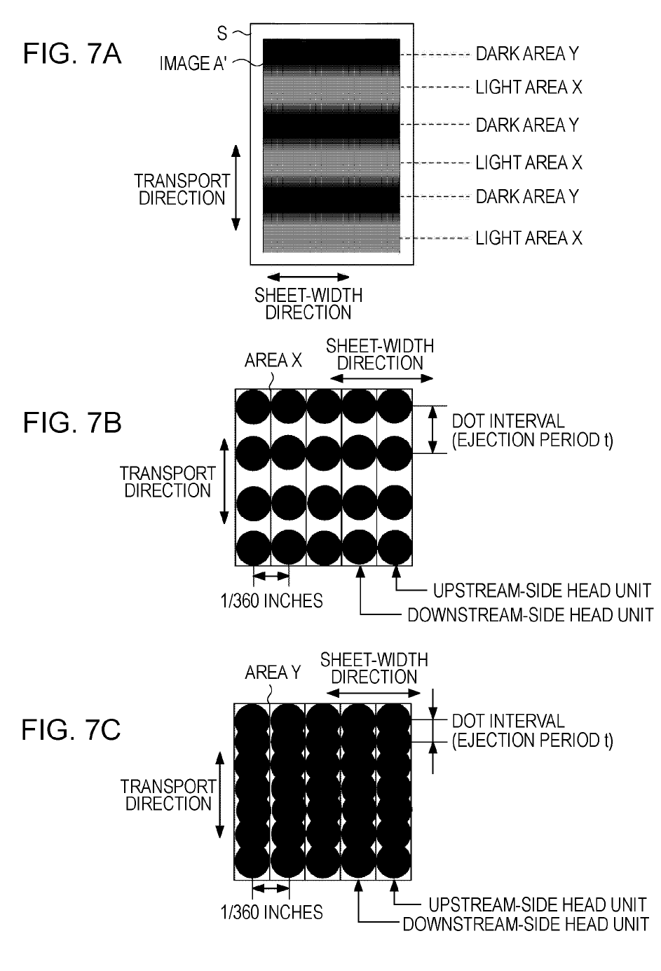

FIG. 7A shows an image A′ printed by the printer according to the comparative example. In the printer according to the comparative example, even if ink is ejected in the interval of ejection period t with respect to a sheet S from the nozzles of the upstream-side head unit 30A and the downstream-side head unit 30B as in the printing of the image A (FIG. 6A), the image A having the constant density shown in FIG. 6A is not printed. That is, the image A′ having uneven density as shown in FIG. 7A is printed. In the image A′, dark areas Y and light areas X are alternately disposed in parallel in the transport direction.

FIG. 7B is an enlarged view of the areas X where the printing is light in the image A′. When (from the time T0 to the time T2 in FIG. 5D) the sheet S is transported at the speed V+ΔV that is greater than the command transport speed V, the areas X oppose the upstream-side head unit 30A and the downstream-side head unit 30B. That the sheet S is transported at the speed (V+ΔV) that is greater than the command transport speed means that the sheet S is transported by a length that is longer than 1/360 inches during a time from ejection of ink with respect to the areas X from a certain nozzle to a next ejection of ink. As a result, as shown in FIG. 7B, dot rows whose intervals are wider than 1/360 inches in the transport direction are formed in the areas X. Therefore, compared to the image A in which uneven density does not occur as shown in FIG. 6B, a dot formation density is low in the areas X, and the areas X form an image that is lighter than the image A as seen macroscopically.

FIG. 7C is an enlarged view of the areas Y where the printing is dark in the image A′. When (from the time T2 to the time T4 in FIG. 5D) the sheet S is transported at the speed (V−ΔV) that is less than the command transport speed V, the areas Y oppose the upstream-side head unit 30A and the downstream-side head unit 30B. That is, the sheet S is transported by a length that is shorter than 1/360 inches during a time from ejection of ink with respect to the areas Y from a certain nozzle to a next ejection of ink. As a result, as shown in FIG. 7C, dot rows whose intervals are narrower than 1/360 inches in the transport direction are formed in the areas Y. Therefore, compared to the image A in which uneven density does not occur as shown in FIG. 6B, a dot formation density is high in the areas Y, and the areas Y form an image that is darker than the image A as seen macroscopically.

To recapitulate, in the printer in which a speed change occurs due to a transport error, the interval in the transport direction of the dot rows formed when the sheet S is transported at a speed than is greater than the command transport speed V is wider than 1/360 inches. In contrast, the interval in the transport direction of the dot rows formed when the sheet S is transported at a speed that is less than the command transport speed V is narrower than 1/360 inches.

As in the printer according to the comparative example, when the upstream-side head unit 30A opposes a certain area of the sheet S when the sheet S is transported at a speed that is greater (less) than the command transport speed, and when the transport speed of the sheet S when the certain area of the sheet S opposes the downstream-side head unit 30B becomes greater (less) than the command transport speed V, the following occurs. That is, the dot rows having intervals that are wider (narrower) than 1/360 inches in the transport direction are adjacent to each other in the sheet-width direction. As a result, the areas X where printing is light as shown in FIG. 7B and the areas Y where the printing is dark as shown in FIG. 7C are formed (that is, uneven density occurs), thereby reducing image quality.

Accordingly, the embodiment aims at reducing uneven density occurring due to a transport error (transport characteristic).

The previous description only explains the case in which the dot interval is wide in the transport direction (FIG. 7B) and the case in which the dot interval is narrow in the transport direction (FIG. 7C). However, the periodic speed change caused by a transport error gradually increases or decreases as shown in FIG. 5D. Therefore, the intervals in the transport direction of the dot rows that are formed are gradually widened or narrowed. Therefore, when an attempt is made to print an image having a constant density with the printer according to the comparative example, an uneven density exhibiting gradation occurs so that the image becomes gradually light and dark. Since the speed change is periodic, the image A′ in which the dark areas Y and the light areas X alternate is formed.

### Head Unit Interval X

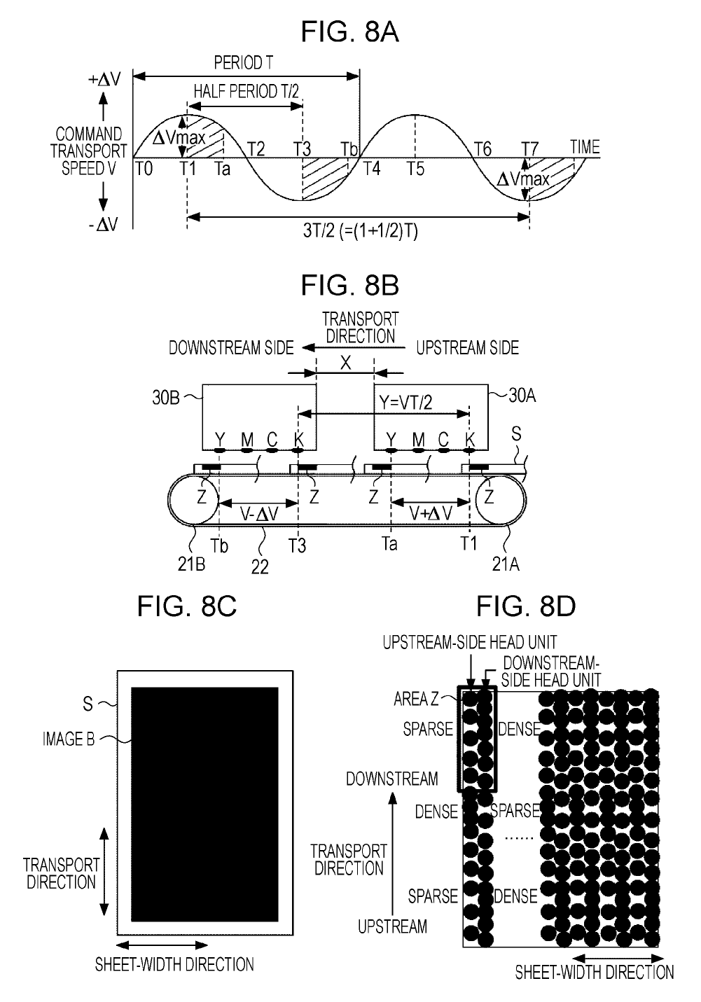

FIG. 8A shows the transport characteristic of the printer 1 according to the embodiment (=FIG. 5D). FIG. 8B shows the head unit interval X in the printer 1 according to the embodiment. FIG. 8C shows an image B formed with the printer 1 according to the embodiment. FIG. 8D is an enlarged view of the image B. The image B is formed by ejecting ink from each nozzle of the upstream-side head unit 30A and the downstream-side head unit 30B at the interval of ejection period t. When the image B is to be formed, a sheet S is transported to the transporting unit 20 whose speed changes as shown in FIG. 8A with respect to the command transport speed V.

Here, attention will be focused upon a certain area Z (black portion) of the sheet S. At the time T1 in FIG. 8A, a front end of an area Z opposes an uppermost-stream-side nozzle row K of the upstream-side head unit 30A (see FIG. 8B). Then, the sheet S is transported, so that, at a time Ta in FIG. 8A, a back end of the area Z opposes a lowermost-stream-side nozzle row Y of the upstream-side head unit 30A. That is, when the sheet S is transported at the speed (V+ΔV) that is greater than the command transport speed V, the area Z opposes the upstream-side head unit 30A. Therefore, the interval in the transport direction of dot rows that are formed with the upstream-side head unit 30A in the area Z is wider than 1/360 inches.

Then, at a time T3 in FIG. 8A, the front end of the area Z opposes an uppermost-stream-side nozzle row K of the downstream-side head unit 30B. Then, at a time Tb, the back end of the area Z opposes a lowermost-stream-side nozzle Y of the downstream-side head unit 30B. That is, when the sheet S is transported at the speed (V−ΔV) that is less than the command transport speed V, the area Z opposes the downstream-side head unit 30B. Therefore, the interval in the transport direction of dot rows that are formed with the downstream-side head unit 30B in the area Z is narrower than 1/360 inches.

That is, in the area Z, the upstream-side head unit 30A forms dot rows whose interval in the transport direction is wider than 1/360 inches, and the downstream-side head unit 30B forms dot rows whose interval in the transport direction is narrower than 1/360 inches (the dot rows are densely formed in the transport direction). In the area Z (indicated by a thick-line frame) shown in FIG. 8D, the sparse dot row in the transport direction and the dense dot row in the transport direction are adjacent to each other in the sheet-width direction.

In the printer according to the aforementioned comparative example, the sparse dot rows in the transport direction are formed adjacent to each other in the transport direction in the area X (FIG. 7B), while the dense dot rows are formed adjacent to each other in the transport direction in the area Y (FIG. 7C). Therefore, uneven density occurs in the printed image due to the areas having a high dot formation density and the areas having a low dot formation density. In contrast, in the embodiment, since the sparse dot rows in the transport direction and the dense dot rows in the transport direction are formed adjacent to each other in the sheet-width direction, the dot formation density differences are reduced. Therefore, when FIG. 8D is viewed macroscopically, the image B having a constant density is formed as shown in FIG. 8C.

That is, in the embodiment, when the upstream-side head unit 30A forms a dense dot row in the transport direction in a certain area (area Z) of the sheet S, the downstream-side head unit 30B forms a sparse dot row in the transport direction. In contrast, when the upstream-side head unit 30A forms a sparse dot row in the transport direction, the downstream-side head unit 30B forms a dense dot row in the transport direction. Accordingly, even if the interval in the transport direction of dot rows to be formed is not constant, a sparse dot row and a dense dot row to be formed in a certain area are combined, so that the dot formation density differences in the certain area are reduced, thereby reducing the occurrence of uneven density.

Therefore, when the transport speed of the sheet S when a certain area of the sheet S opposes the upstream-side head unit 30A is higher (lower) than the command transport speed V, the transport speed of the sheet S when the certain area of the sheet S opposes the downstream-side head unit 30B is lower (higher) than the command transport speed V. That is, the speed error (+ΔV) with respect to the command transport speed V when the certain area of the sheet S opposes the upstream-side head unit 30A and the speed error (−ΔV) with respect to the command transport speed V when the certain area of the sheet S opposes the downstream-side head unit 30B are symmetrical values.

Accordingly, the head unit interval X according to the embodiment is set so that a period from when a certain area of the sheet S opposes the uppermost-stream-side nozzle row K of the upstream-side head unit 30A (time T1) to when the certain area of the sheet S opposes the uppermost-stream-side nozzle row K of the downstream-side head unit 30B (time T3) becomes equal to a half period (T/2) of the transport characteristic (FIG. 8A). That is, the head unit interval X is set so that the interval between the uppermost-stream-side nozzle row K of the upstream-side head unit 30A and the uppermost-stream-side nozzle row K of the downstream-side head unit 30B becomes equal to the distance that the sheet S is transported in the half period (T/2).

For example, in the aforementioned description, the transport speed at the time t1 when the front end of an area Z opposes the uppermost-stream-side nozzle row K of the upstream-side head unit 30A becomes a value resulting from adding a maximum speed error ΔVmax to the command transport speed V (that is, V+ΔVmax). In addition, the transport speed at the time T3 when the front end of the area Z opposes the uppermost stream nozzle row K of the downstream-side head unit 30B becomes a value resulting from subtracting the maximum speed error ΔVmax from the command transport speed V (that is, V−ΔVmax). Further, the speeds are symmetrically changed so that, while the upstream-side head unit 30A performs printing on the area Z (T1 to Ta) the transport speed of the sheet S is gradually reduced from the value (V+ΔVmax), whereas, while the downstream-side head unit 30B performs printing on the area Z (T3 to Tb) the transport speed of the sheet S is gradually increased from the value (V−ΔVmax). As a result, the interval in the transport direction of the dot rows to be formed in the area Z with the upstream-side head unit 30A is gradually reduced, whereas the interval in the transport direction of the dot rows to be formed in the area Z with the downstream-side head unit 30B is gradually increased.

Since the speed changes periodically due to a transport error, as shown in FIG. 8D, in an area situated upstream from the area Z, the upstream-side head unit 30A forms a dense dot row, and the downstream-side head unit 30B forms a sparse dot row, which is the reverse to that in the area Z. That is, when the upstream-side head unit 30A forms dot rows in the transport direction in the order “sparse dot row, dense dot row, sparse dot row, . . . ,” the downstream-side head unit 30B forms dot rows in the transport direction in the order “dense dot row, sparse dot row, dense dot row, . . . ,” to restrict uneven density.

However, since the uppermost-stream-side nozzle row of the upstream-side head unit 30A and the uppermost-stream-side nozzle row of the downstream-side head unit 30B are not necessarily nozzle rows for the same color, the interval X is set so that the interval between the nozzle row of the upstream-side head unit 30A and that of the downstream-side head unit 30B for the same color becomes equal to the distance that the sheet S is transported in the half period (T/2) of the transport characteristic.

In the embodiment, as shown in FIG. 3, the disposition of the nozzle rows of the upstream-side head unit 30A and that of the nozzle rows of the downstream-side head unit 30B are the same, so that in both of the head units, the nozzle rows are disposed in the order KCMY from the upstream side. In addition, the intervals between the nozzle rows for the same colors of the upstream-side head unit 30A and the downstream-side head unit 30B are all the same. Therefore, if the interval between the nozzle rows for one color among the nozzle rows of the upstream-side head unit 30A and the downstream-side head unit 30B is determined on the basis of the transport characteristic (T/2), uneven density of ink ejected from the nozzle rows for the other colors is also reduced.

When the disposition of the nozzle rows of the upstream-side head unit 30A and that of the nozzle rows of the downstream-side head unit 30B are not the same as it is in the embodiment, intervals between some nozzle rows of the same colors among the intervals between the nozzle rows of the same colors of the upstream-side head 31A and the downstream-side head 31B, and the interval between the black ink nozzle rows K whose uneven densities tend to stand out are set on the basis of the transport characteristic (T/2). Even in this case, uneven density is reduced.

In the case in which many nozzle rows are formed in the head units 30, and the lengths of the head units 30 become long, if the head unit interval X is determined on the basis of the half period T/2 of the transport characteristic, the setting position of the upstream-side head unit 30A and that of the downstream-side head unit 30B overlap each other. In such a case, the head unit interval X is set so that a duration from when the sheet S opposes the uppermost-stream-side nozzle row K of the upstream-side head unit 30A to when the sheet S opposes the uppermost-stream-side nozzle row K of the downstream-side head unit 30B is equal to (natural number R+1/2)T(=3T/2, 5T/2, 7T/2 . . . ). That is, the interval X is set so that the interval between the uppermost-stream-side nozzle row K of the upstream-side head unit 30A and the uppermost-stream-side nozzle row K of the downstream-side head unit 30B is equivalent to the distance that the sheet S is transported in the duration resulting from adding the half period T/2 of the transport characteristic to the natural-number multiple period. For example, when the head unit interval X is determined on the basis of 3T/2 (R=1), as shown in FIG. 8A, the speed errors ΔV with respect to the command transport speed V when the sheet S opposes the upstream-side head unit 30A and when the sheet S opposes the downstream-side head unit 30B are symmetrical values.

Since the density of the sparse dot rows formed with one of the head units 30 is compensated by the density of the dense dot rows formed with the other head unit 30, the ink ejected from the upstream-side head unit 30A and that ejected from the downstream-side head unit 30B need to be the same color. In addition, printing needs to be carried out with both the upstream-side head unit 30A and the downstream-side head unit 30B.

### Method of Manufacturing Printer 1

When the printer 1 has the transport characteristic shown in FIG. 8A, the dot rows formed with each head unit and extending along the transport direction are formed by alternately disposing dense areas, in which dot intervals of dot rows are small, and sparse areas, in which dot intervals of dot rows are large (FIG. 8D). The length in the dot row direction from the central portion of a certain dense area in a dot row to a central portion of another dense area adjacent to the certain dense area in the dot row direction (transport direction) is equal to a predetermined length. This predetermined length is equivalent to the distance that the sheet S is transported during the period T of the transport characteristic of the printer 1. Since the transport speed becomes gradually slower or faster due to the transport characteristic, the dot intervals of the dot rows also change in such a way that the density gradually increases and then gradually decreases. The dense areas in which the dot intervals of the dot rows are small refer to areas of the dot rows formed when the sheet S is transported more slowly than the command transport speed V. In contrast, the sparse areas in which the dot intervals of the dot rows are small refer to areas of the dot rows formed when the sheet S is transported faster than the command transport speed V.

In addition, in the embodiment, for example, the length in the dot row direction from the central portion of the dense area of the dot row formed with the upstream-side head unit 30A (the area where the dot interval of the dot row becomes smallest), that is, the area formed when the speed error with respect to the command transport speed V in FIG. 8A is largest at −ΔVmax), to the central portion of dense area of the dot row formed with the downstream-side head unit 30B (area where the dot interval of the dot row becomes smallest) is equal to a length value resulting from adding an integral multiple (which is greater than or equal to zero) of the predetermined length to a length obtained by dividing the predetermined length by 2 (number n of nozzle groups is equal to 2). That is, the length in the dot row direction from the central portion of the dense area of the dot row formed with the upstream-side head unit 30A to the central portion of the dense area of the dot row formed with the downstream-side head unit 30B is made equivalent to the distance that the sheet S is transported in a duration (T/2, 3T/2, 5T/2, . . . ) resulting from adding a duration of an integral multiple (which is greater than or equal to zero) period (0, T, 2T, 3T, . . . ) to a duration of the half period T/2 of the transport characteristic. This reduces uneven density.

Accordingly, the head unit interval X is set so that the interval between the nozzle row of the upstream-side head unit 30A and the nozzle row of the downstream-side head unit 30B is equivalent to the distance that the sheet S is transported in the duration (T/2, 3T/2, 5T/2, . . . ) resulting from adding the duration of the integral multiple (which is greater than or equal to zero) period to the duration of the half period T/2 of the periodic speed change (transport characteristic) occurring due to a transport error. Therefore, if the head unit interval X is set as mentioned above, uneven density is reduced as mentioned above.

Consequently, in the embodiment, first, the transport characteristic (periodic speed change) is detected, and the head unit interval X is set on the basis of the transport characteristic. However, since the transport characteristic differs depending upon printers, in the manufacturing process, it is necessary to detect the transport characteristic of each printer, and determine the head unit interval X for each printer. The method of detecting the transport characteristic and the method of determining the head unit interval X in the manufacturing method will be described below.

### EXAMPLE 1 OF MANUFACTURING PRINTER 1

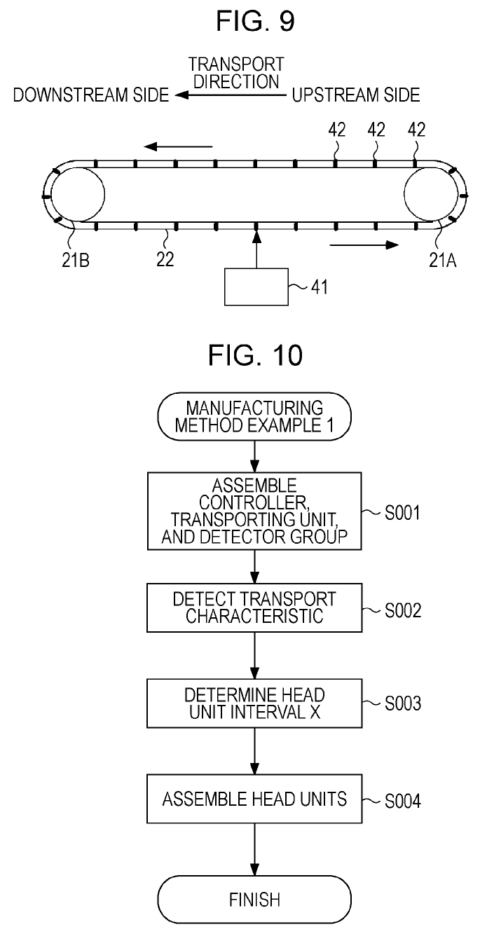

FIG. 9 shows a method of detecting the transport characteristic with a speed detection sensor 41. FIG. 10 is a flowchart of a manufacturing method example 1. In the manufacturing method example 1, the speed detecting sensor 41 (speed detecting unit) detects the transport characteristic from the rotational speed of the transport belt 22. Therefore, when the controller 10, the transporting unit 20, and the detector group 40 are assembled (S001), the transport characteristic is detected (S002) prior to assembling the head units 30.

To detect the transport characteristic from the rotational speed of the transport belt 22, marks 42 (such as slits or magnetic sensors) are provided at certain intervals at the transport belt 22. Then, the controller 10 of the printer 1 controls the transport belt 22 so that it rotates at the constant command transport speed V, and causes the speed detecting sensor 41 to detect the marks 42.

If the transport belt 22 is rotating at a constant speed without any transport error, the speed detecting sensor 41 detects the marks at a certain interval. However, if a speed change occurs due to a transport error as shown in FIG. 8A, the interval in which the speed detecting sensor 41 detects the marks 42 no longer becomes constant. For example, when the transport belt 22 rotates faster than the command transport speed V, the interval in which the speed detector 41 detects the marks 42 is reduced. In contrast, when the transport belt 22 rotates more slowly than the command transport speed V, the interval in which the speed detecting sensor 41 detects the marks 42 is increased. Accordingly, the periodic transport characteristic of the transporting unit 20 shown in FIG. 8A can be detected on the basis of the interval in which the speed detecting sensor 41 detects the marks 42.

Then, on the basis of the detected transport characteristic, the head unit interval X is determined (S003) so that a duration from when a sheet S opposes the uppermost-stream-side nozzle row K of the upstream-side head unit 30A to when the sheet S opposes the uppermost-stream-side nozzle row K of the downstream-side head unit 30B becomes T/2 of the period T of the transport characteristic or (natural number R+1/2)T. Then, when the head units 30 are assembled (S004) so that the interval between the upstream-side head unit 30A and the downstream-side head unit 30B becomes the head unit interval X determined (in S003), the printer 1 whose uneven density caused by a transport error is restricted is completed, and is shipped to a user.

The speed detecting sensor 41 may be provided only when the transport characteristic during the manufacturing process is detected, or may be provided at the printer 1 at all times. Although the controller 10 is previously described as controlling the transport amount of the sheet S on the basis of the rotational angle of the transport roller 21 using the transport rollers 21 using, for example, a rotary encoder (not shown), when the printer 1 includes the speed detecting sensor 41 at all times, the transport speed during printing may be controlled with the speed detecting sensor 41.

### EXAMPLE 2 OF METHOD OF MANUFACTURING PRINTER 1

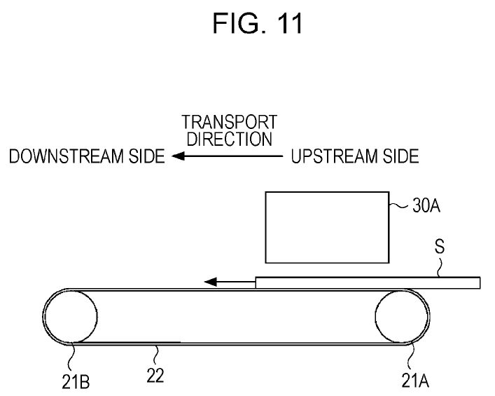

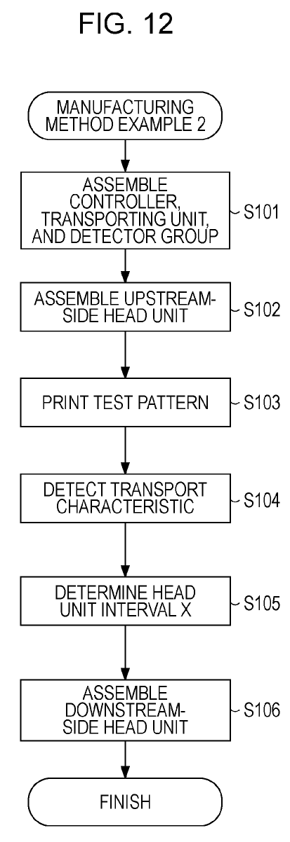

FIG. 11 shows a method of detecting the transport characteristic with the upstream-side head unit 30A. FIG. 12 is a flowchart of the manufacturing method example 2. In the manufacturing method example 2, the upstream-side head unit 30A is used to print a test pattern on a sheet S. Then, the transport characteristic is detected on the basis of the printed test pattern. Accordingly, after assembling the controller 10, the transporting unit 20, and the detector group 40 (S101), only the upstream-side head unit 30A is assembled (S102). In every printer, the upstream-side head unit 30A is assembled at the same position, but the setting position of the downstream-side head unit 30B differs according to each printer on the basis of the head unit interval X determined later. Two examples of the test pattern will hereunder be given.

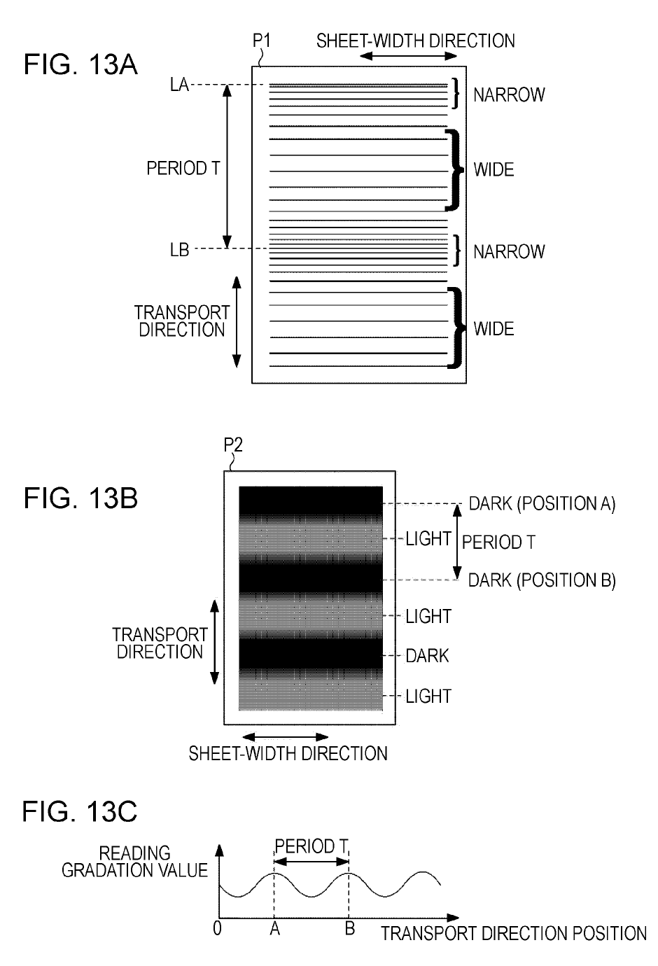

FIG. 13A shows a first test pattern P1. The controller 10 controls the transporting unit 20 so that the sheet S is transported at the command transport speed V, and causes the nozzle rows of one color (black nozzle rows) of the upstream-side head unit 30A to eject ink simultaneously at a certain interval, so that the first test pattern P1 is formed. Ejecting ink simultaneously from the black nozzle rows forms lines along the sheet-width direction. Actually, one line is not formed in the sheet-width direction because the heads 31 are disposed in a staggered arrangement as shown in FIG. 3. Here, the black nozzles are assumed as being disposed in one row in the sheet-width direction for simplifying the description).

When the sheet S is transported at the constant command transport speed V without any transport error, the lines of the black nozzle rows are disposed in parallel at a certain interval in the transport direction. However, when a transport error occurs as shown in FIG. 8A, the interval in the transport direction of the lines of the black nozzle rows changes periodically so as to become narrower and wider as shown in FIG. 13A.

The interval between the lines formed when the sheet S is transported at a speed that is higher than the command transport speed V become wider, whereas, the interval between the lines formed when the sheet S is transported at a speed that is lower than the command transport speed V become narrower. Therefore, the transport characteristic shown in FIG. 8A can be detected from the ejection interval of the ink from the black nozzle rows and the interval between adjacent lines in the transport direction. For example, as shown in FIG. 13A, a duration from when a line LA (the interval being smallest between adjacent lines) is formed (corresponding to the time T3 in FIG. 8) to when a line LB (the interval being smallest the next between adjacent lines) is formed (corresponding to a time T7 in FIG. 8A) corresponds to the period T of the transport characteristic.

FIG. 13B shows a second test pattern P2. FIG. 13C shows a result of reading the second test pattern P2 with a scanner. The controller 10 controls the transporting unit 20 so that the sheet S is transported at the command transport speed V, and prints an image of a certain density (corresponding to a constant gradation value) with one nozzle row (black nozzle row K) of the upstream-side head unit 30A, so that the second test pattern P2 is formed.

When the sheet S is transported at the constant command transport speed V without any transport error, an image having a constant density shown in FIG. 6A is printed. However, when a speed change occurs due to a transport error as shown in FIG. 8A, an image having uneven density is printed. As a result, as shown in FIG. 13C, the reading result obtained using the scanner changes periodically so that the reading gradation value (vertical axis) becomes higher or lower with respect to positions in the transport direction shown along the horizontal axis.

As mentioned above, sparse dot rows are formed in the transport direction in the areas in which the sheet S is subjected to printing at a speed that is higher than the command transport speed V, so that the density of these areas becomes less than the density specified from the controller 10. In contrast, dense dot rows are formed in the transport direction in the areas in which the sheet S is subjected to printing at a speed that is lower than the command transport speed V, so that the density of these areas becomes greater than the specified density. Therefore, from the result of the reading gradation value and the command transport speed V of the sheet S, the transport characteristic shown in FIG. 8A can be detected. For example, the duration from when the darkest area of the second test pattern P2 is printed, that is, from when a position A in the transport direction, where the result of the reading gradation value (FIG. 13C) becomes a maximum, is subjected to printing (time T3 in FIG. 8A) to when the following darkest area is printed (time T7 in FIG. 8A) corresponds to the period T of the transport characteristic shown in FIG. 8A.

Accordingly, after detecting the transport characteristic shown in FIG. 8A (S104) on the basis of the test patterns P1 and P2 printed with the upstream-side head unit 30A, the head unit interval X is determined (S105) on the basis of the period T of the transport characteristic. Then, when the downstream-side head unit 30B is assembled (S106) in accordance with the determined head unit interval X, a printer 1 whose uneven density caused by a transport error is restricted is finished.

Here, a specific head unit interval X will be considered. The head unit interval X is set so that an interval Y (FIG. 8B) between the uppermost-stream-side nozzle row of the upstream-side head unit 30A and the uppermost-stream-side nozzle row of the downstream-side head unit 30B becomes equal to the distance that the sheet S is transported in the half period T/2 of the transport characteristic. That is, the interval Y is the distance that the sheet S is transported from the time T1 to the time T3 in FIG. 8A, and is represented by an area that is bordered by the time axis (horizontal axis) and the speed change from the time T1 to the time T3 (sinusoidal wave). The average value of the transport speed of the sheet S from the time T1 to the time T3 corresponds to the command transport speed V, and the interval Y=V×T/2. The value resulting from subtracting, for example, from the interval Y the distance between nozzle rows or the distance between the nozzle row and an end of the head unit corresponds to the head unit interval X.

Among the printed test patterns P1 and P2, for example, in the first test pattern P1 (FIG. 13A), the interval between the line LA (the interval being the smallest between adjacent lines) and the line LB (the interval being the smallest the next between adjacent lines) may correspond to the distance that the sheet S is transported in the period T. Therefore, it is possible to measure the interval between the lines LA and LB, and to set the length equivalent to half the measured interval as the interval Y between the uppermost-stream-side nozzle row of the upstream-side head unit and the uppermost-stream-side nozzle row of the downstream-side head unit. Alternatively, the length equal to (the interval between the line LA and the line LB)×(natural number R+1/2) may be set as the interval Y between the uppermost-stream-side nozzle row of the upstream-side head unit and the uppermost-stream-side nozzle row of the downstream-side head unit.

Here, although the interval Y and the head unit interval X are determined on the basis of the transport characteristic with respect to the command transport speed V, even if the sheet S is transported at a speed other than the command transport speed V, the occurrence of uneven density is reduced. Since the pressing of the cross section of, for example, the transport rollers 21 and the displacement of the rotation center influence the transport characteristic the most, the periodic transport characteristic is generated each time the transport rollers 21 rotate once. Therefore, for example, when the transport speed of the sheet is twice (2V) the command transport speed V, the transport rollers rotate at twice the speed. Therefore, a period T′ of the transport characteristic when the transport speed is 2V is equal to half the period T shown in FIG. 8A (T′=T/2). In addition, when the transport speed is 2V, a time Tx at which the sheet S is transported in the interval Y (=VT/2) is equal to half of the period T1′(=T/2) when the transport speed is 2V. That is, Tx=(VT/2)/(2V)=T/4). Therefore, the duration Tx from when the sheet S opposes the uppermost-stream-side nozzle row of the upstream-side head unit 30A to when the sheet S opposes the uppermost-stream-side nozzle row of the downstream-side head unit 30B becomes the half of the period (=T′/2) of the period T′ of the transport characteristic with respect to the transport speed 2V. Consequently, the occurrence of uneven density is reduced.

### EXAMPLE 3 OF METHOD OF MANUFACTURING PRINTER 1

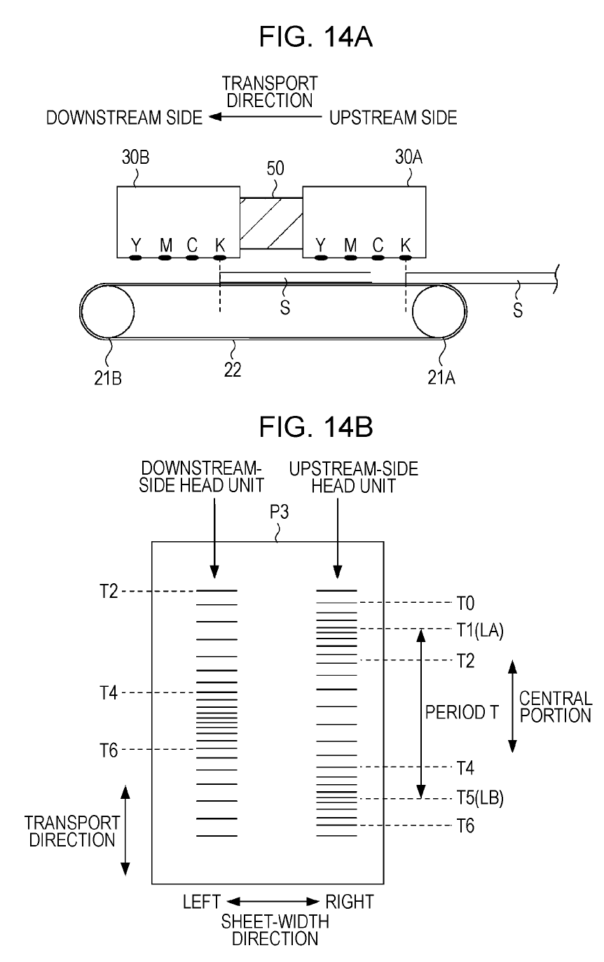

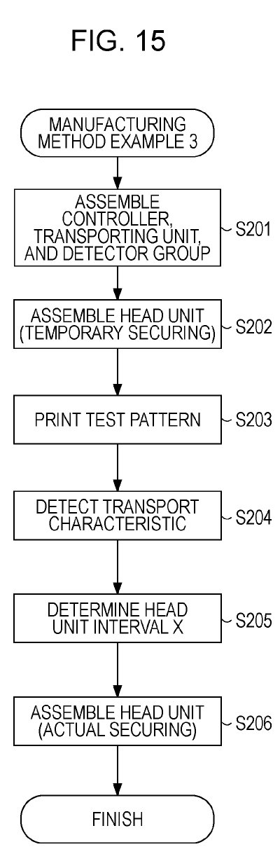

FIG. 14A shows a method of detecting the transport characteristic with the two head units. FIG. 15 is a flowchart of the manufacturing method example 3. In the manufacturing method example 3, after the controller 10, the transporting unit 20, and the detector group 40 are assembled (S201), the upstream-side head unit 30A is assembled. In addition, the downstream-side head unit 30B is also installed through a spacer 50 (S202). At this time, the downstream-side head unit 30B is temporarily secured at a temporary installation position. Then, a third test pattern P3 is printed (S203).

FIG. 14B shows the third test pattern P3. The controller 10 controls the transporting unit 20 so that the sheet S is transported at the command transport speed V, and causes the black nozzle row K of the upstream-side head unit 30A and the black nozzle row K of the downstream-side head unit 30B to eject ink simultaneously at a certain interval, so that the third test pattern P3 is formed. In addition, ink is only ejected from the right black nozzle row K of the upstream-side head unit 30A in the sheet-width direction and the left black nozzle row K of the downstream-side head unit 30B in the sheet-width direction. As shown in FIG. 14B, this causes the upstream-side head unit 30A to form a plurality of lines on the right side of the sheet S, and the downstream-side head unit 30B to form a plurality of lines on the left side of the sheet S. In the manufacturing method example 3, the head unit interval X is determined by detecting the transport characteristic from the relationship between the positions of the lines formed on the left and right sides of the sheet S. In the actual head units 30, since the heads 31 are disposed in a staggered arrangement as shown in FIG. 3, it is possible to print the third test pattern P3 using only the upstream-side head or the downstream-side head 31 among the heads disposed in a staggered arrangement. For example, the left lines of the third test pattern P3 are printed with the third head 31B(3) in the downstream-side head unit 30B, and the right lines of the third test pattern P3 are printed with the first head 31A(1) in the upstream-side head unit 30A.

When the intervals between the lines formed in the third test pattern P3 are not constant, that is, when, as shown in FIG. 14B, the line intervals increase and decrease, it can be understood that a speed change (transport characteristic) as shown in FIG. 8A occurs in the printer due to a transport error.

For example, in FIG. 14B, when one focuses attention upon the lines at the central portion of the sheet S in the transport direction, the intervals between the right lines formed with the upstream-side head unit 30A are wide, whereas the intervals between the left lines formed with the downstream-side head unit 30B are narrow. Accordingly, when the upstream-side head unit 30A and the central portion of the sheet S oppose each other, the sheet S is transported at a speed that is higher than the command transport speed V. In contrast, when the downstream-side head unit 30B and the central portion of the sheet S oppose each other, it can be understood that the sheet S is transported at a speed that is lower than the command transport speed V. As shown in FIG. 8A, the central portion of the sheet S opposes the upstream-side head unit 30A from the time T0 to the time T2, and the central portion of the sheet S opposes the downstream-side head unit 30B from the time T2 to the time T4.

That is, when, as shown in FIG. 14B, the third test pattern P3 in which the lines whose intervals are small and the lines whose intervals are wide are adjacent to each other at the left and right sides in the sheet-width direction, a speed error when a certain area of the sheet S opposes the upstream-side head unit 30A and a speed error when the certain area of the sheet S opposes the downstream-side head unit 30B are symmetrical values. As a result, when the dots formed with the upstream-side head unit 30A and those formed with the downstream-side head unit 30B are combined, the dot formation density differences are reduced, thereby reducing the occurrence of uneven density. In such a case, the position where the downstream-side head unit 30B is temporarily set with the spacer 50 corresponds to a proper setting position of the downstream-side head unit 30B, and the length of the spacer 50 in the transport direction becomes a proper head unit interval X.

In contrast, when the intervals between the left and right lines of the third test pattern P3 are equal to each other (not shown), for example, when the upstream-side head unit 30A forms lines of wide intervals in the transport direction on the right side of the sheet S, and the downstream-side head unit 30B forms lines of wide intervals in the transport direction on the left side of the sheet S, the dot formation density differences are not reduced, thereby resulting in uneven density. That is, it can be understood that the position where the downstream-side head unit 30B is temporarily set with the spacer 50 is not a proper position. In this case, the head unit interval X is determined so that the lines whose intervals are small and the lines whose intervals are large are disposed adjacent to each other on the left and right sides. For example, referring to FIG. 14B, the duration from when the line LA (the interval being smallest between adjacent lines in the transport direction) is formed to when the line LB (the interval being smallest the next between adjacent lines) is formed corresponds to the period T of the transport characteristic. Then, the head unit interval X is determined on the basis of the transport characteristic T/2 or (R+1/2)T.

On the basis of the proper head unit interval X determined in this way, the downstream-side head unit 30B is actually secured (S206), so that the printer 1 is completed.

### Other Embodiments

In the above-described embodiments, the printing system using an ink jet method is primarily described, and, for example, the methods of setting the head unit interval is discussed. In addition, the above-described embodiments are for facilitating understanding of the invention, and is not to be interpreted as limiting the invention. Obviously, modifications and improvements may be made in the invention without departing from the gist of the invention, and the invention includes equivalents thereof. In particular, the invention also includes the following embodiments.

### Fine Adjustment Mechanism

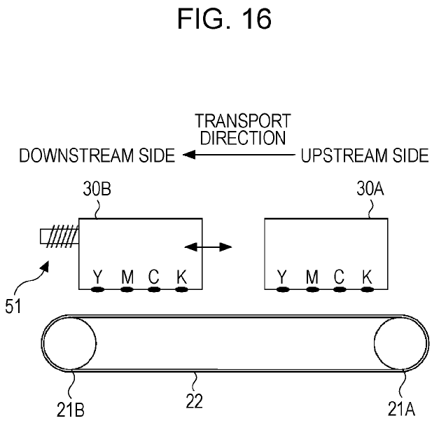

FIG. 16 shows a printer including a fine adjustment mechanism 51 that allows the downstream-side head unit 30B to move in the transport direction using, for example, a bolt. In this case, the head unit interval X can be easily adjusted not only during the manufacturing process of the printer 1, but even after the printer 1 is completed. For example, when a failure occurs in the transporting unit 20, so that only the transporting unit 20 is to be replaced, the head unit interval X can be adjusted in accordance with the transport characteristic of the replaced transporting unit 20 (method of adjusting the liquid ejecting apparatus, nozzle interval adjuster). The head unit interval X may be adjusting either automatically or manually with the fine adjustment mechanism.

Since the head unit interval X can be adjusted if either one of the two head units 30 is movable in the transport direction, either one of the head units 30 (for example, the upstream-side head unit 30A) may be fixed. When only one of the head units 30 moves, it is easier to adjust the head unit interval X, so that errors due to the adjustment rarely occurs.

### Head Unit Interval

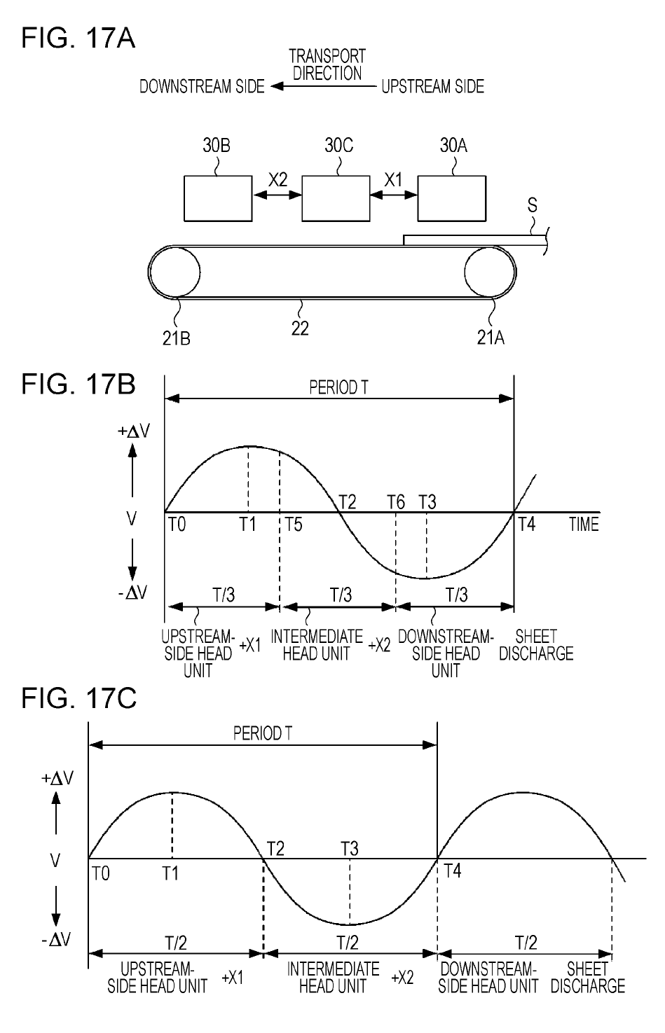

FIG. 17A shows a printer including three head units 30. FIG. 17B shows a relationship between a transport characteristic and a position of each head unit 30 (30A, 30B, and 30C). FIG. 17C shows a relationship between the position of each head unit and a transport characteristic in which uneven density occurs. As shown in FIG. 17A, in the printer including three head units 30 (number of head units 30 is odd, and is represented by n), an interval X1 between the upstream-side head unit 30A and the intermediate head unit 30C is determined so that a duration from when an uppermost-stream-side nozzle row of the upstream-side head unit 30A opposes a sheet S to when an uppermost-stream-side nozzle row of the intermediate head unit 30C opposes the sheet S becomes ⅓ of a period T of the transport characteristic (that is, T/3=T/n). That is, the interval X1 is determined so that the interval between the uppermost side nozzle rows of the two head units that are adjacent to each other in the transport direction becomes equivalent to a distance that the sheet S is transported in a duration (T/3, 4T/3, 7T/3, . . . ) resulting from adding a duration of an integral multiple (greater than or equal to zero) period to a duration (=T/3) obtained by dividing the period T of the transport characteristic by the number of head units 30 (n=3) of the printer. An interval X2 between the intermediate head unit 30C and the downstream-side head unit 30B is set in a similar way. Therefore, the intervals between the three head units are equal to each other.

Therefore, as shown in FIG. 17B, when a transport speed when a certain area of the sheet S opposes the upstream-side head unit 30A (that is, from a time T0 to a time T5) is greater than a command transport speed V, the following occurs. That is, a transport speed when the certain area of the sheet S opposes the intermediate head unit 30C (that is, from the time T5 to a time T6) changes from a speed that is higher than the command transport speed V to a speed that is lower than the command transport speed V; and a transport speed when the certain area of the sheet S opposes the downstream-side head unit 30B (that is, from the time T6 to the time T4) is lower than the command transport speed V.

As a result, in the certain area of the sheet S, the upstream-side head unit 30A forms dot rows whose intervals are wider than 1/360 inches (length of one pixel in the transport direction) in the transport direction, and the downstream-side head unit 30B forms dot rows whose intervals are narrower than 1/360 inches in the transport direction. Dot intervals in the transport direction of dot rows formed with the intermediate head unit 30C are wider than 1/360 inches at the upstream side in the certain area, and are narrower than 1/360 inches towards the downstream side. Therefore, on average, the dot intervals in the transport direction of the dot rows formed with the intermediate head unit 30B become 1/360 inches. Consequently, in the sheet S, the dot rows whose dot intervals are wider than approximately 1/360 inches, the dot rows whose dot intervals are on average approximately 1/360 inches, and the dot rows whose dot intervals are narrower than 1/360 inches are disposed side by side in the sheet-width direction. Therefore, the dot formation density differences are reduced, thereby reducing the occurrence of uneven density.

In the printer including an odd number of head units (three heads), the head unit interval X cannot be determined on the basis of the half period (T/2) of the transport characteristic as it is in the foregoing embodiments. For example, as shown in FIG. 17C, when the transport speed when the upstream-side head unit 30A opposes a certain area of the sheet S is higher than the command transport speed V, the transport speed when the intermediate head unit 30C opposes the certain area of the sheet S is lower than the command transport speed V, and the transport speed when the downstream-side head unit 30B opposes the certain area of the sheet S is lower than the command transport speed V. As a result, the upstream-side head unit 30A and the downstream-side head unit 30B form the dot rows whose dot intervals in the transport direction are wider than 1/360 inches, and the intermediate head unit 30C forms the dot rows whose dot intervals in the transport direction are narrower than 1/360 inches. Therefore, the density of the certain area becomes lower than a specified density, thereby resulting in uneven density.

Therefore, when the number of head units of the printer is an odd number (n), the head unit interval (such as X1) is set so that a duration from when the uppermost-stream-side nozzle row of, for example, the upstream-side head unit (such as the head unit 30A adjacent to the other head units in the transport direction) opposes the sheet S to when the uppermost-stream-side nozzle row of the downstream-side head unit (such as the head unit 30C) opposes the sheet S becomes Tn of the period T of the transport characteristic (or (R+1/n)T).

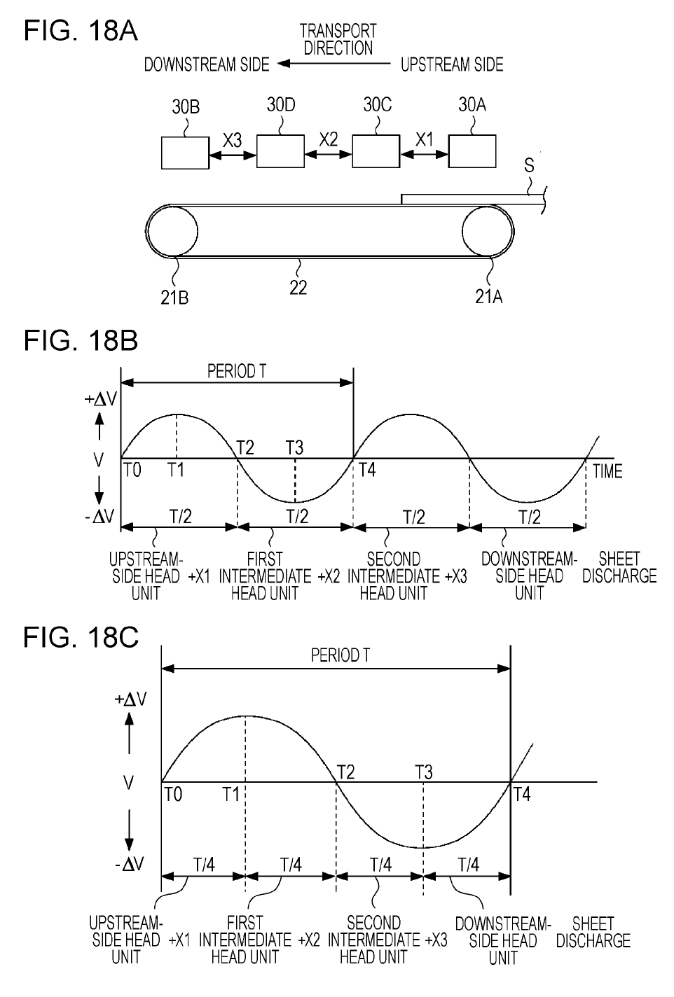

FIG. 18A shows a printer including four head units. FIGS. 18B and 18C show relationships between a transport characteristic and a position of each head unit (30A to 30D). When the number of head units (represented by n) of the printer is even, a head unit interval (such as X1) is set so that a duration from when an uppermost-stream-side nozzle row of the upstream-side head unit (such as the head unit 30A adjacent to the other head units in the transport direction) opposes a sheet S to when an uppermost side nozzle row of the downstream-side head unit (such as the head unit 30C) opposes the sheet S becomes T/n ((R+1/n)T) or T/2 ((R+1/2)T) of a period T of the transport characteristic.

FIG. 18B shows the relationship between the position of each head unit 30 and the transport characteristic when the head unit interval X is set on the basis of T/2 of the period T of the transport characteristic. In this case, as shown in FIG. 18B, the upstream-side head unit 30A and the second intermediate head unit 30D form dot rows whose dot intervals are wide in the transport direction, and the first intermediate head unit 30C and the downstream-side head unit 30B form dot rows whose dot intervals are narrow in the transport direction. Therefore, dot formation density differences are reduced, thereby reducing the occurrence of uneven density.

FIG. 18C shows the relationship between the position of each head unit 30 and a transport speed when the head unit interval X is set on the basis of T/n (T=4) of the period T of the transport characteristic. In this case, transport speeds when the upstream-side head unit 30A and the downstream-side head unit 30B oppose the sheet S change symmetrically. Therefore, when the dot rows formed with the upstream-side head unit 30A and the downstream-side head unit 30B are combined, the dot formation density differences are reduced. Similarly, transport speeds when the first intermediate head unit 30C and the second intermediate head unit 30D oppose the sheet S also change symmetrically. Therefore, when the dot rows formed with the two intermediate head units 30C and 30D are combined, dot formation density differences are reduced. As a result, the occurrence of uneven density is reduced.

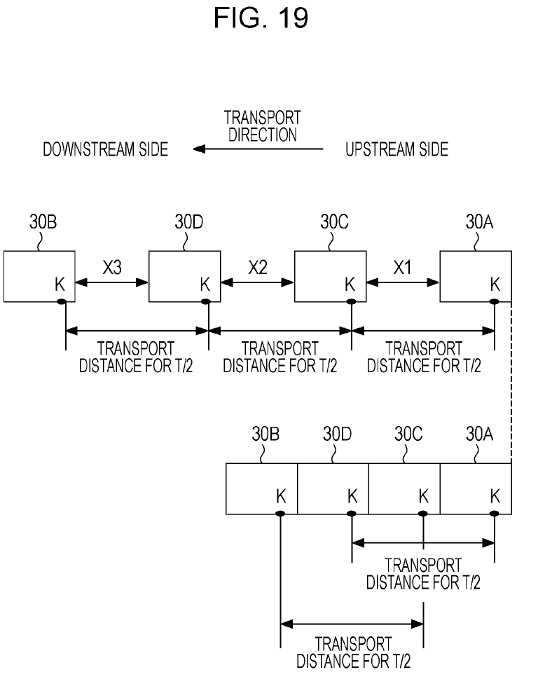

In the foregoing description, when the number of head units is even, as shown in FIG. 17B, each pair of head units each that are adjacent to each other in the transport direction can overcome the problem of uneven density. That is, when the upstream-side head unit 30A forms sparse dot rows, uneven density is reduced by forming dense dot rows with the first intermediate head unit 30C. In addition, when the second intermediate head unit 30D forms sparse dot rows, uneven density is reduced by forming dense dot rows with the downstream-side head unit 30B. Accordingly, the uneven density is reduced using all four head units. However, uneven density can be reduced in other ways. When the upstream-side head unit 30A forms sparse dot rows, the second intermediate head unit 30D, instead of the first intermediate head unit 30C that is adjacent to the upstream-side head unit 30A in the transport direction, may form dense dot rows, to reduce uneven density. That is, the interval between a nozzle row K of the upstream-side head unit 30A and a nozzle row K of the second intermediate head unit 30D is caused to be equal to the distance that the sheet S is transported in the half period (T/2). If uneven density is reduced by reducing the dot formation density differences using the first intermediate head unit 30C and the downstream-side head unit 30B, the uneven density is reduced using all of the four head units. In this case, as shown in FIG. 19, since the upstream-side head unit 30A and the first intermediate head unit 30C are brought as close to each other as possible, the size of the apparatus can be reduced.

Although, in the previous embodiments, the head unit interval X is determined on the basis of the half period T/2 of the transport characteristic, the invention is not limited thereto. When the duration of period T of the transport characteristic is long, and, for example, a periodic uneven density does not occur even if the second test pattern P2 (FIG. 13B) is printed, the uneven density caused by a transport error is believed to only slightly influence image quality deterioration. Therefore, in such a case, no problems arise when the head unit interval X is made as small as possible to reduce apparatus size and printing time.

### Test Pattern

Although, in the previous embodiments, the test patterns P1 to P3 are printed on the sheet S, the invention is not limited thereto. For example, it is possible to print the test patterns P1 to P3 on the transport belt 22, to adjust the head unit interval X. However, it is necessary the clean the transport belt 22 after printing the test patterns on the transport belt 22.

### Liquid Ejecting Apparatus

Although, in the previous embodiments, an ink jet printer is used as an example of the liquid ejecting apparatus, the invention is not limited thereto. As long as a liquid ejecting apparatus is used, the invention is applicable not only to a printer, but also to various industrial apparatuses. For example, the invention is applicable to, for example, a textile printer for forming a pattern on a cloth, a display manufacturing device, such as a color filter manufacturing device or an organic EL display, a DNA chip manufacturing device that manufactures a DNA chip by applying a solution containing DNA to the chip, or a circuit substrate manufacturing device.

Although, in the printers according to the previous embodiments, liquid is ejected by expanding and contracting an ink chamber as a result of applying a voltage to a driving element (piezo element), the invention is not limited thereto. For example, a printer that ejects a liquid by bubbles generated in a nozzle using a heating element may be used.

What is claimed is:

1. A liquid ejecting apparatus comprising:
a transport mechanism that transports a medium in a transport direction with respect to nozzles that eject a liquid; and
n number of nozzle groups,
wherein dot rows along the transport direction formed with the nozzle groups are formed by alternately disposing in parallel, dense areas, where dot intervals of the dot rows are small, and sparse areas, where dot intervals of the dot rows are large, and a length in a direction of the dot rows from a central portion of a particular one of the dense areas to a central portion of another particular one of the dense areas is a predetermined length, and
wherein a length in the dot row direction from a central portion of a particular one of the dense areas of one of the dot rows formed with a certain one of the nozzle groups among the n number of nozzle groups to a central portion of a particular one of the dense areas of one of the dot rows formed with another one of the nozzle groups, differing from the certain one of the nozzle groups, is equal to a length resulting from adding an integral multiple of the predetermined length to a length obtained by dividing the predetermined length by n, the integral multiple being greater than or equal to zero.

2. A liquid ejecting apparatus comprising:
a transport mechanism that transports a medium in a transport direction with respect to nozzles that eject a liquid;
a first upstream-side nozzle group; and
a first downstream-side nozzle group positioned downstream from the first upstream-side nozzle group in the transport direction,
wherein an interval between a particular one of the nozzles of the first upstream-side nozzle group and a particular one of the nozzles of the first downstream-side nozzle group is equal to a distance that the medium is transported in a duration resulting from adding a duration of an integral multiple period to a duration of a half period of a period in which a speed change occurs due to a transport characteristic of the transport mechanism, the integral multiple being greater than or equal to zero.

3. The liquid ejecting apparatus according to claim 2, wherein a type of liquid ejected from the first upstream-side nozzle group is the same as a type of liquid ejected from the first downstream-side nozzle group, and wherein the first downstream-side nozzle group forms dot rows along the transport direction between dot rows formed along the transport direction with the first upstream-side nozzle group.

4. The liquid ejecting apparatus according to claim 2, further comprising:
a second upstream-side nozzle group positioned between the first upstream-side nozzle group and the first downstream-side nozzle group; and
a second downstream-side nozzle group positioned downstream from the first downstream-side nozzle group in the transport direction,
wherein an interval between a particular one of the nozzles of the second upstream-side nozzle group and a particular one of the nozzles of the second downstream-side nozzle group is equal to a distance that the medium is transported in the duration resulting from adding the duration of the integral multiple period to the duration of the half period of the period in which the speed change occurs, the integral multiple being greater than or equal to zero.

5. The liquid ejecting apparatus according to claim 2, wherein, when an area of the medium opposing the first upstream-side nozzle group when the medium is transported at a speed that is higher than a speed specified on the basis of the transport characteristic opposes the first downstream-side nozzle group, the medium is transported at a speed that is lower than the speed specified on the basis of the transport characteristic.

6. A liquid ejecting apparatus comprising:
a transport mechanism that transports a medium in a transport direction with respect to nozzles that eject a liquid; and
n number of nozzle groups,
wherein an interval between a particular one of the nozzles of an upstream-side nozzle group among two of the nozzle groups that are adjacent to each other in the transport direction and a particular one of the nozzles of a downstream-side nozzle group among the two of the nozzle groups that are adjacent to each other in the transport direction is equal to a distance that the medium is transported in a duration resulting from adding a duration of an integral multiple period to a duration of a period obtained by dividing a period of a speed change, caused by a transport characteristic of the transported mechanism, by n, the integral multiple being greater than or equal to zero.
